(19) United States
(12) Patent Application Publication
(10) Pub. No.: US 2014/0164275 A1
(43) Pub. Date: Jun. 12, 2014

(54) SYSTEMS AND METHODS FOR MOBILE DEVICE DONATIONS TO CHARITABLE ORGANIZATIONS

(71) Applicant: Angela C. Lee, Charlotte, NC (US)

(72) Inventor: Angela C. Lee, Charlotte, NC (US)

(21) Appl. No.: 13/712,893

(22) Filed: Dec. 12, 2012

(51) Int. Cl. G06Q 20/32

(52) U.S. Cl. CPC G06Q 20/322
USPC 705/329

(57) ABSTRACT

Systems and methods for automated, mobile device-based donations to charitable organizations including software operable on mobile communications devices.

### BACKGROUND OF THE INVENTION

1. Field of the Invention

The present invention relates to mobile communications device software, systems, and methods for making charitable donations for organizations.

2. Description of the Prior Art

At the time of the present invention, there are about one million software applications (apps) for mobile smart phone products on the market. A small subset of those apps is directed at charitable donations, and some of the most popular ones are identified below. These apps are mostly found on a specific software and hardware combination, namely the commercially available Android platform supported by Google, and Apple smartphone apps notably have prevented or avoided allowing direct donations from apps.

Apps providing for charitable donations include, by way of commercial example:

Paypal has added a donations feature to their popular mobile application, allowing donations to be made easily to more than 23,000 charities. See: http://www.talkandroid.com/26825-paypal-mobile-is-making-it-easier-for-you-to-donate-to-your-favorite-charity/.

SecureGive allows a person to make a one time or a recurring donation to multiple donation categories through any smart phone or tablet device. See: http://securegive.com/mobilegiving.html.

Donation Connect allows users to scroll through a list of participating organizations to donate to. The donations are charged to the user's phone bill or deducted from a prepaid balance. See: http://www.appolicious.com/shine/apps/159383-donation-connect-rosetta-marketing-strategies-group/developer_notes.

Church On The Go provides an app that allows users to make a donation to their church of choice regardless of where they are. See: http://appworld.blackberry.com/webstore/content/13942/?lang=en.

Pure Charity provides a commercially available web-based app described as providing downloadable software allowing users to discover projects and start campaigns related to the causes they are passionate about, inviting users to use sharing of the app Pure Charity with their social networks (via Facebook, Twitter, etc.). See: https://www.purecharity.com/.

Swiss Charity is another site that provides for support of the causes and projects of the organizations, associations, and NGOs close to users' heart with a single click. Donations are added to the bill of their mobile phone provider. See: http://www.swiss-charity.org/.

Charity Catalog describes a site that includes a downloadable app that functions to collect and catalogs links to charity sites that allow users to give money to them simply by clicking a button and viewing an advertisement, then the advertisers pay a small amount of cash to charity sites. See: http://www.androidpit.com/en/android/market/apps/app/com.zemlik.charitycatalog/Charity-Catalog.

Charity Budget provides an app for aiding a person to plan and budget their charitable donations, which includes graphically visualizing contributions, saving a budget plan, and tracking progress over time. Also has a feature to share their goals and budget with friends or family by simply tapping “e-mail”. See: http://www.androidpit.com/en/android/market/apps/app/com.aspiring.charitybudget/Charity-Budget.

Givatron site indicates that it allows users to easily find and make mobile donations of any amount to any registered charity in North America. Donors immediately receive an official tax receipt via e-mail; by way of example, consider the website See: http://www.androidpit.com/en/android/market/apps/app/org.benevity.mobile.android.givatron/Givatron-Give-to-Charity.

My Charity Box is donation-processing page customized for each user that allows users to start accepting online donations in minutes and works from a website, facebook page, and even on donors' mobile phones. See: https://mycharitybox.com/.

There are numerous applications for connecting with your friends, including for example, Facebook, Twitter, LinkedIn, Foursquare, Find My Friends, Pinterest, Skype, MySpace, and Google+.

### SUMMARY OF THE INVENTION

The present invention relates to software, systems and methods for automated, mobile device-based donations to charitable organizations.

It is an object of this invention to provide a method for making electronic donations with a mobile communication device including the steps of providing an interactive user interface and software on a mobile communications device having a processor and a memory, wherein the software is operable for creating, launching, initiating, or starting a new charitable donation campaign, event, and/or organization automatically, based upon user inputs. The device receives inputs from a user through an interactive user interface, and includes information for making an electronic donation or charitable contribution through network-based communication by the device to a remote server computer, which provides for further processing of the electronic donation. Preferably, the device operates with wireless communication of the donation information.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIGS. 1-8 show schematic diagrams of one embodiment of the invention illustrating a mobile smartphone communications device and user interface therefor.

FIG. 9 is a schematic diagram illustrating a virtualized computing network used in of one embodiment of the invention for automated systems and methods.

### DETAILED DESCRIPTION

Referring now to the drawings in general, the illustrations are for the purpose of describing a preferred embodiment of the invention and are not intended to limit the invention thereto.

The present invention provides systems, methods, and apparatus embodiments for a software application (app) operation on a mobile communication device in wireless communication over a network with at least one server computer, wherein the software is operable on a smartphone or other wireless communication device for providing user-interactive graphic user interfaces allowing inputs for secure donations to charitable organizations. Furthermore, the present invention provides for the functions of donation, creating a new charitable organization donation recipient or donation event recipient, and updating to allow users to input donations made outside the app, and to update the tracking, recording, and reporting functions of the app for that user.

In one embodiment, a method for making electronic donations with a mobile communication device is provided, including the steps of providing an interactive user interface and software on a mobile communications device having a processor and a memory, wherein the software is operable for creating, launching, initiating, or starting a new charitable donation campaign, event, and/or organization automatically, based upon user inputs. The device receives inputs from a user through an interactive user interface, and includes information for making an electronic donation or charitable contribution through network-based communication by the device to a remote server computer, which provides for further processing of the electronic donation.

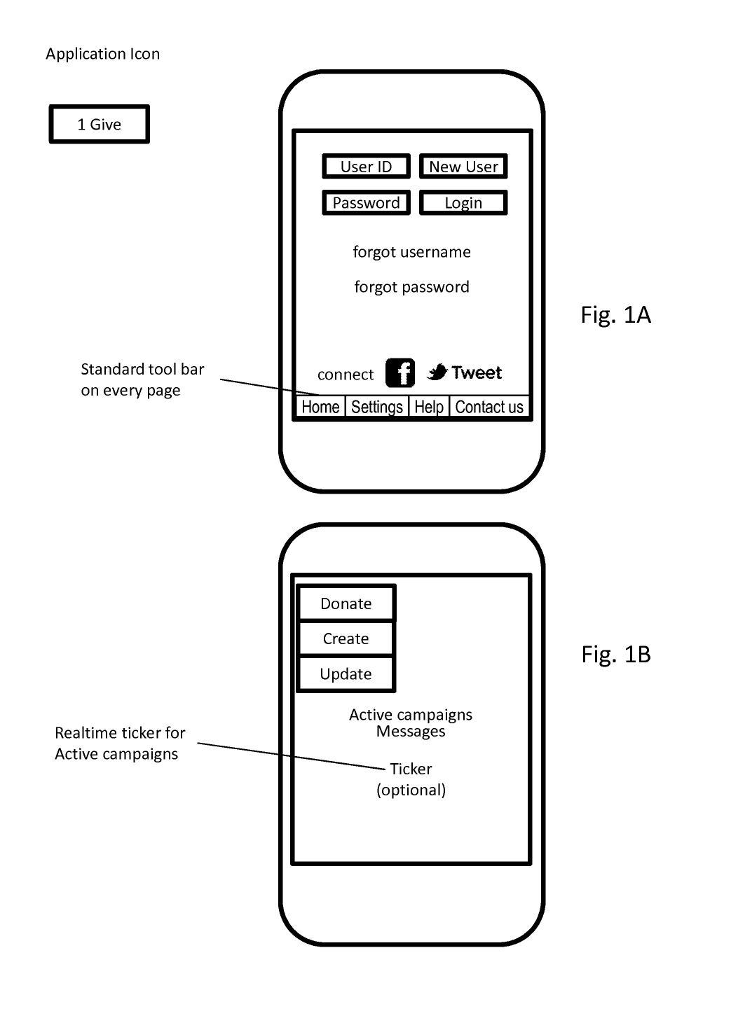

FIGS. 1-8 show schematic diagrams of one embodiment of the invention illustrating a mobile smartphone communications device and user interface therefor. More particularly, FIG. 1A illustrates a display and a graphic user interface provided thereon for receiving interactive user inputs from functional touchscreen display keys or selection indicators. A standard toolbar is illustrated at the bottom horizontal section of the display, showing touchscreen display keys or selection indicators for HOME, SETTINGS, HELP, and CONTACT US. In another area of the display, touchscreen key displays or selection indicators are provided for USER ID, NEW USER, PASSWORD, LOGIN, FORGOT USERNAME, and FORGOT PASSWORD options for interactive selection and subsequent input steps allowing a device user to provide inputs. For example, a unique user identification and login combination, such as a username and password combination.

FIG. 1B shows options for user selection and inputs for the three key top level functions of the systems, methods, and apparatus of the present invention, namely, DONATE, CREATE, and UPDATE. As indicated hereinabove, the function of donation by the user to at least one charitable organization, event, or entity is provided by software for an interactive graphic user interface (GUI), and the other functions of creating a new charitable organization donation recipient or donation event recipient, and updating to allow users to input donations made outside the app, and to update the tracking, recording, and reporting functions of the app for that user are further accessible from the same display, as illustrated in FIG. 1B. The create function provides for creating a campaign, including entry of information for account information, i.e., financial institution and financial account information to be provided for secure database storage, and for use for future donation transactions. The create function also provides for simple peer to peer transfers for the benefit of private campaigns, by way of example and not limitation, a school fundraiser, private gifting, family function, group travel, etc. The update function provides for receiving inputs identifying donations made outside the app, i.e., not made within the app software, but wherein the user would like to have a record, tracking, and/or reporting of that donation, individually and in the context of the other donations made by the user over a predetermined time, and within the app (or outside the app but updated). Thus, the present invention advantageously provides for user donations, recording, tracking, and/or reporting of all charitable donations within the app. Also, preferably, the present invention provides for interfacing and/or synchronizing with tax preparation software by providing outputs for inclusion in the charitable giving or donations section or area thereof. Reporting, including generation of electronic (display) or printable versions, is provided for predetermined time periods, e.g., weekly, monthly, quarterly, annually, and combinations thereof.

FIG. 1B may further provide for a real-time or near-real-time “ticker” or updating indication for predetermined fundraising campaigns or events that the user preferences or inputs indicate for monitoring.

In preferred embodiments of the present invention, the software provides interactive user interface on a mobile communications device operable for creating, launching, initiating, or starting a new charitable donation campaign, event, and/or organization to which that same user, and/or a multiplicity of users may remotely via smartphone app use of the present invention may later provide donations or charitable contributions. In one embodiment, non-profit or other charitable organizations may push or send information to users via the app and wireless communications platform, and the users may activate or select those predetermined or pushed donation recipients for making donations or contributions. Furthermore, those donation recipients may further provide information including updates, initiatives, campaigns, events, use of funds, progress toward a target or goal for fundraising, and combinations thereof.

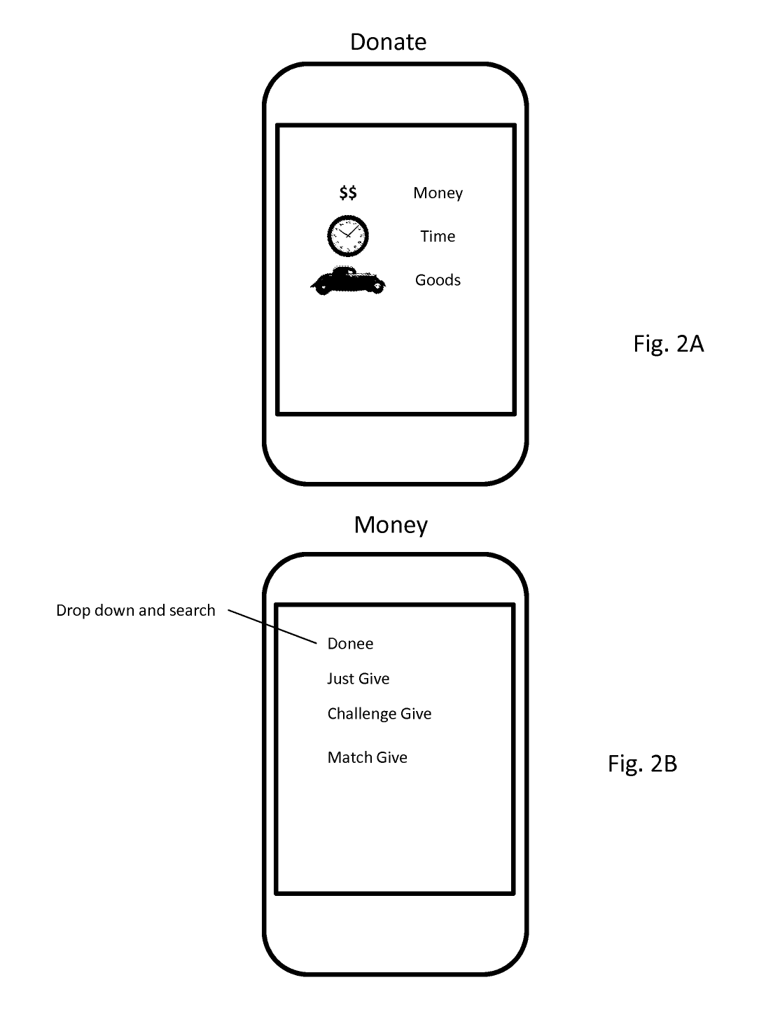

FIGS. 2-8 also illustrate a display and a graphic user interface provided thereon for receiving interactive user inputs from functional touchscreen display keys or selection indicators. FIG. 2A illustrates a GUI for donation function operation, including options for donation of financial contributions or money, time, and goods or services. FIG. 2B illustrates options for the DONEE listing (which may be provided by a drop-down menu or listing for click-select activation or indication of donation by the user through the GUI; other functional touchscreen options are illustrated, including JUST GIVE, CHALLENGE GIVE, and MATCH GIVE.

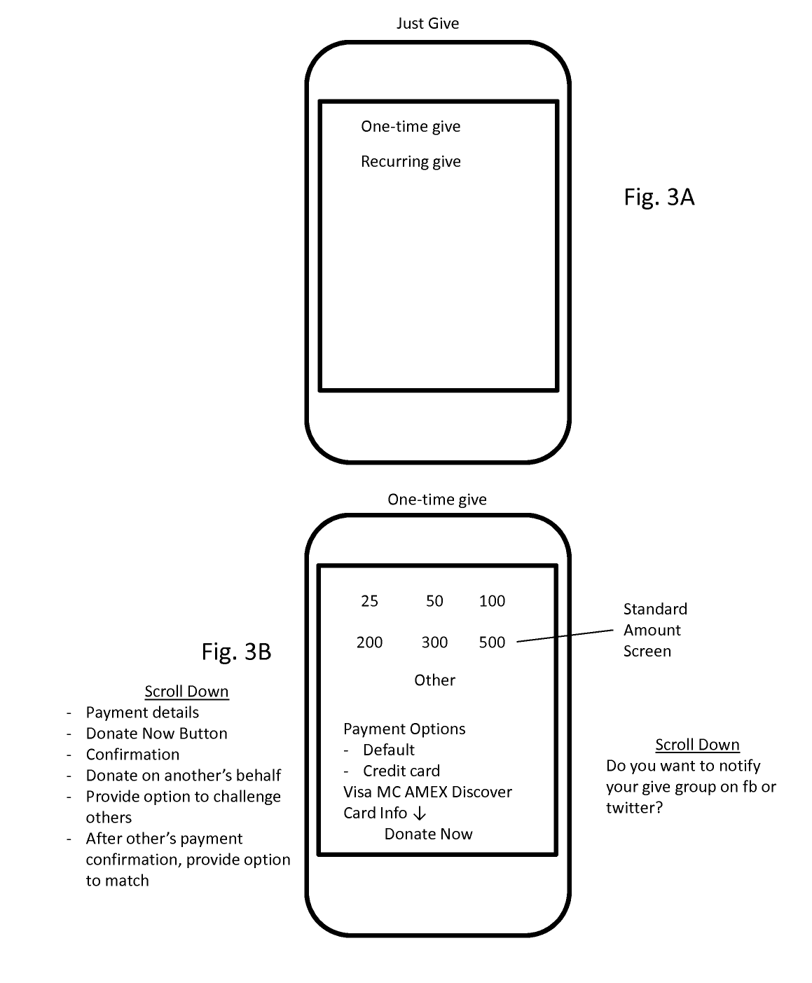

FIG. 3A illustrates options for JUST GIVE, including ONE TIME GIVE and RECURRING GIVE selections or activation choices. FIG. 3B shows ONE TIME GIVE detail on a separate, subsequent GUI, which follows user click select or touchscreen select of that option. Standard monetary giving amounts for donations are shown, in dollar increments (note that currency may be modified by the user preferences). Another scroll down or selection option includes payment details, timing of donation (DONATE NOW), confirmation, donation for user and/or third party, challenge others option, matching, and combinations thereof. Additional options are provided on the GUI, including choices for notification of social network contacts, timing, and method of notification (e.g., Twitter, email, social website posting, text message or SMS messaging, and combinations).

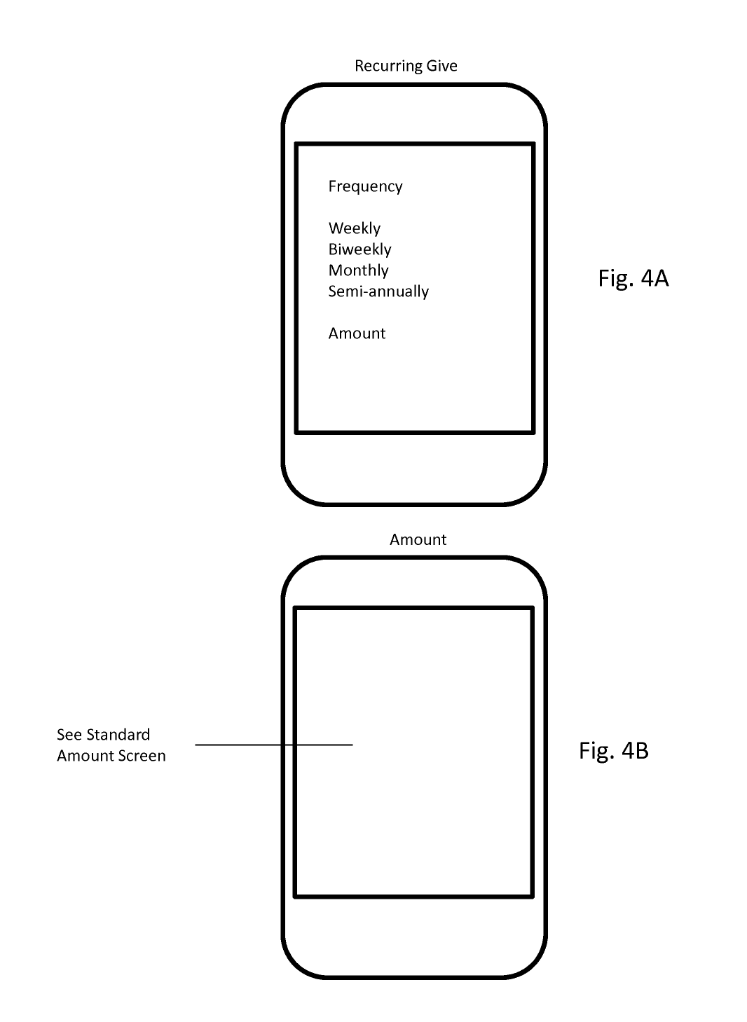

FIG. 4A shows a GUI display for RECURRING GIVE option from FIG. 3A, with additional selections for frequency, by way of example and not limitation, predetermined frequency of weekly, biweekly, monthly, quarterly, semiannually, annually, or user-indicated (e.g., by calendar selection for scheduling donations in the future at selected dates). FIG. 4B provides a GUI for indicating the amount, which may be similar to the standard amount GUI display or screenshot, as in FIG. 3B.

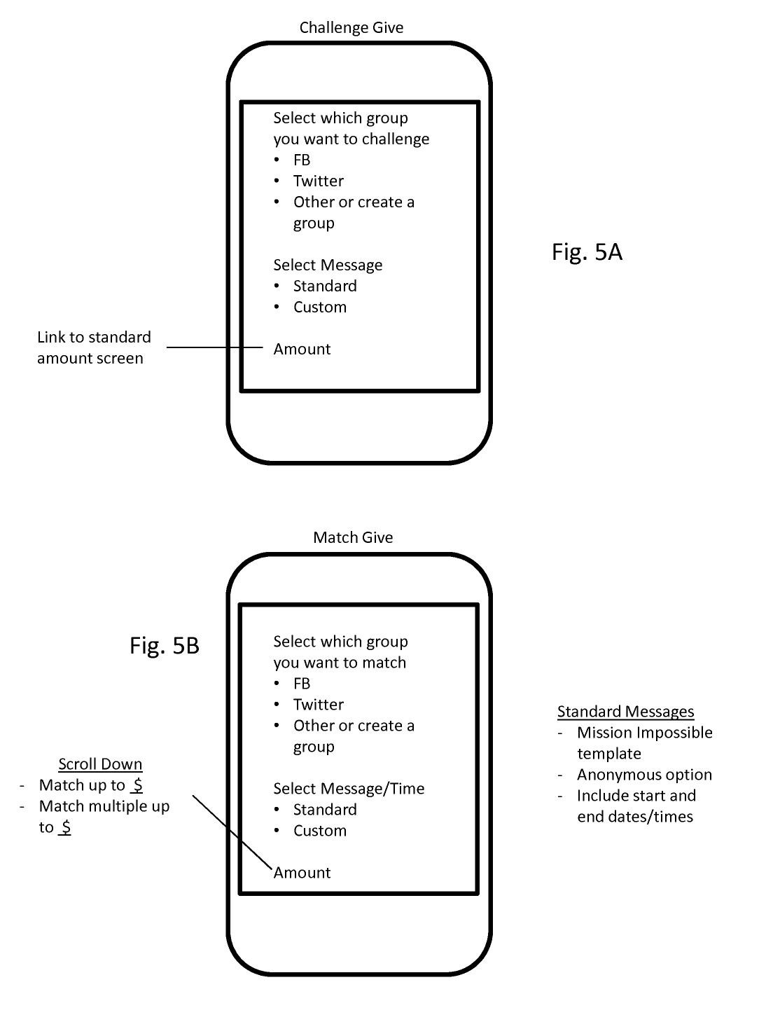

FIG. 5A illustrates a GUI interactive display or touchscreen for CHALLENGE GIVE. FIG. 5B shows a screenshot for MATCH GIVE options, including standard messages and scroll-down options.

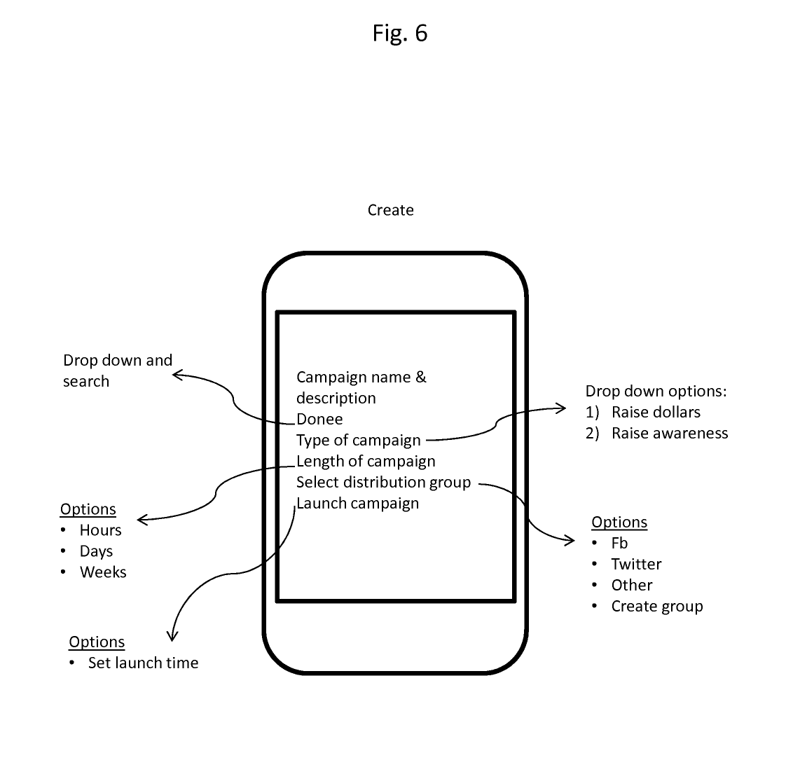

FIG. 6 illustrates the CREATE function, wherein inputs for campaign or event name and description, donnee, type of campaign or event, length or duration of campaign or event, selecting distribution group, and launch campaign options are provided. Some may optionally include drop-down or other menu formats for fundraising details provided by the donation recipient or donee, such as 1) raise dollars; 2) raise awareness. Distribution group options may be listed or entered by the user.

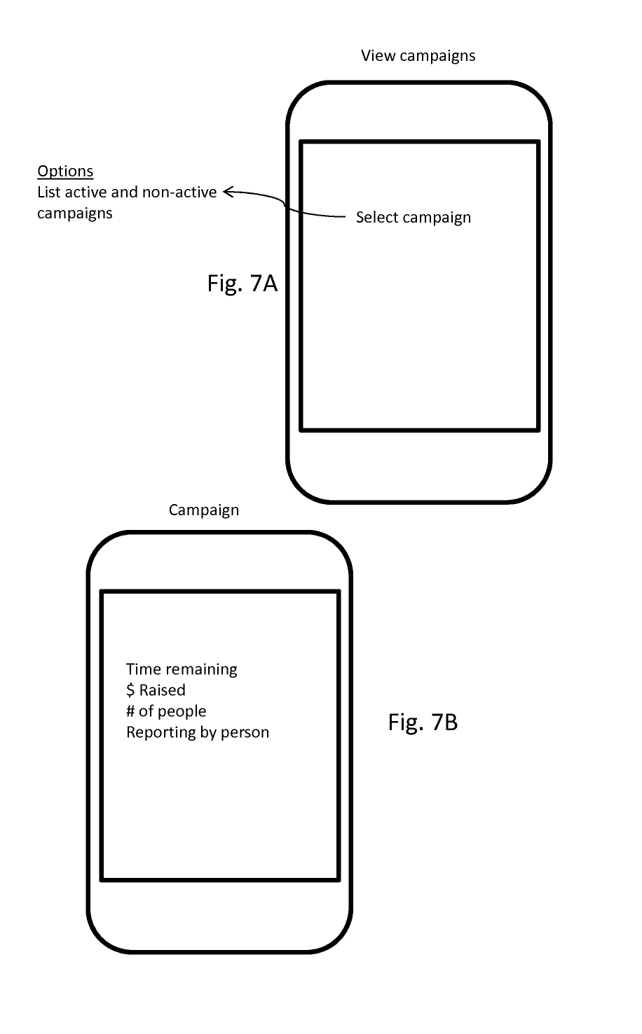

FIG. 7A provides a GUI for viewing campaigns, including a select campaign option for listing active and inactive campaigns within a predetermined time period for that user. Optionally, additional information may be provided, such as summary of giving or donations by the user to each campaign or other report. FIG. 7B shows a GUI for individual campaigns or events for donation, including status details such as time remaining, total financial amount raised in dollars or other currency, number of contributors or individuals participating or making contributions (and by type of contribution, e.g., financial or non-financial), and reporting by contributors, where appropriate.

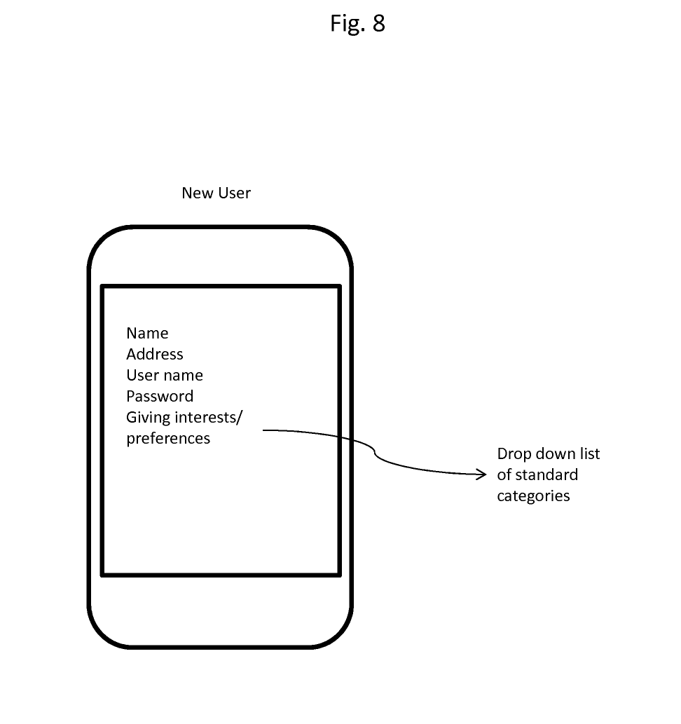

FIG. 8 provides an exemplary GUI for new user data entry, including details of name, address, user identification, password or login, and preferences, including but not limited to user interests. The latter may be provided by click-select, drop down or other GUI menu options, or user input (typing or speech), and may be further categorized or listed by standard groupings (religious, education, healthcare, research, etc.).

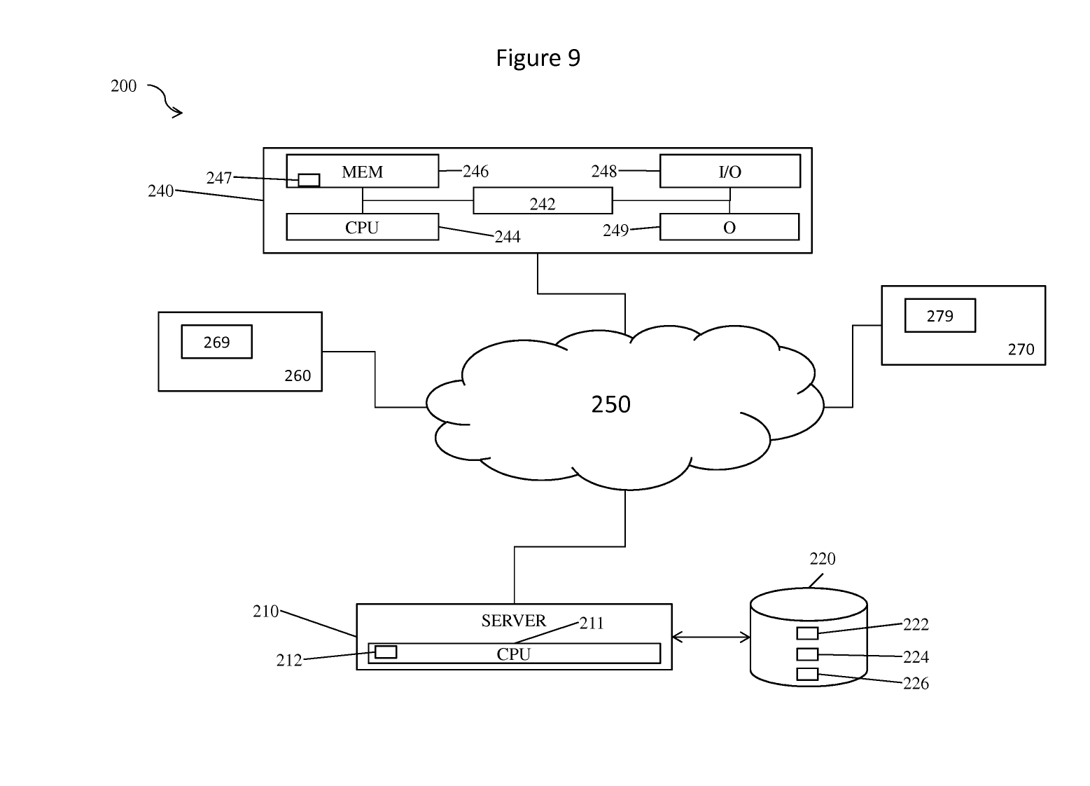

FIG. 9 is a schematic diagram illustrating a virtualized computing network used in of one embodiment of the invention for automated systems and methods. As illustrated, components of the systems and methods include the following components and sub-components, all constructed and configured for network-based communication, and further including data processing and storage. As illustrated in FIG. 1, a basic schematic of some of the key components of a system according to the present invention are shown. The system 200 comprises a server 210 with a processing unit 211. The server 210 is constructed, configured and coupled to enable communication over a network 250. The server provides for user interconnection with the server over the network using a personal computer (PC) 240 positioned remotely from the server. Furthermore, the system is operable for a multiplicity of remote personal computers or terminals 260, 270. For example, a client/server architecture is shown. Alternatively, a user may interconnect through the network 250 using a user device such as a personal digital assistant (PDA), mobile communication device, such as by way of example and not limitation, a mobile phone, a cell phone, smart phone, laptop computer, netbook, a terminal, or any other computing device suitable for network connection. Also, alternative architectures may be used instead of the client/server architecture. For example, a PC network, or other suitable architecture may be used. The network 250 may be the Internet, an intranet, or any other network suitable for searching, obtaining, and/or using information and/or communications. The system of the present invention further includes an operating system 212 installed and running on the server 210, enabling server 210 to communicate through network 250 with the remote, distributed user devices. The operating system may be any operating system known in the art that is suitable for network communication.

Certain modifications and improvements will occur to those skilled in the art upon a reading of the foregoing description. By way of example, donations may include financial contributions, services, in-kind contributions, goods or products, credit or non-monetary contributions of value, time, and combinations thereof. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for making electronic donations with a wireless mobile device comprising the step of:
providing an interactive user interface and software on a mobile communications device having a processor and a memory;
wherein the software is operable for creating, launching, initiating, or starting a new charitable donation campaign, event, and/or organization; and
wherein the device is operable for receiving inputs from a user, the inputs including information for making an electronic donation or charitable contribution through network-based communication by the device to a remote server computer.

2. The method of claim 1, further including the step of the device transmitting the information associated with the electronic donation or charitable contribution to the remote server computer.

3. The method of claim 1, further including the step of the device transmitting at least one message to at least one remote user of a corresponding at least one mobile communication device.

4. The method of claim 1, wherein the network-based communication is wireless communication.
